(19) United States
(12) Patent Application Publication
(10) Pub. No.: US 2009/0099697 A1
(43) Pub. Date: Apr. 16, 2009

(54) Power Supply Switch for Dual Powered Thermostat, Power Supply for Dual Powered Thermostat, and Dual Powered Thermostat

(75) Inventors: Haiqing Li, Beijing (CN); Maria Hernandez, (US)

Correspondence Address: Fleit Gibbons Gutman Bongini & Bianco P.L., 21355 E. Dixie Highway, Suite #115, Miami, FL, 33180, US

(73) Assignee: EAIR, LLC, Miami, FL (US)

(21) Appl. No.: 12/136,865

(22) Filed: Jun. 11, 2008

Related U.S. Application Data
(60) Provisional application No. 60/943,223, filed on Jun. 11, 2007.

(51) Int. Cl. G05B 15/00

(52) U.S. Cl. 700/276

(57) ABSTRACT

A power supply switch for a dual powered thermostat switches the power supply to a dual-powered thermostat with a touch-screen display when a change in primary power supply is detected. The switch switches to an auxiliary power supply. The auxiliary power supply can be a battery.

### CROSS-REFERENCE TO RELATED APPLICATIONS

This application claims the benefit of U.S. Provisional Application No. 60/943,223, filed Jun. 11, 2007.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to power supplies for digital thermostats.

2. Description of the Related Art

Thermostats for controlling climate control systems generally fall into two broad categories: (1) mechanical thermostats and (2) electronic digital thermostats. A typical mechanical thermostat, such as for a multi-stage thermostat application, is connected to an alternating current (AC) power supply, normally a transformer. However, mechanical thermostats do not require continuous electrical power. On the other hand, a typical digital thermostat, such as one that is multi-stage, requires continuous power for thermostat components such as a microcomputer and thermostat control circuit. These component parts require power at all times. Therefore, digital thermostats need additional connections to a power supply, such as a transformer, to satisfy these power requirements.

Thus, when replacing a mechanical multi-stage thermostat with a digital multi-stage thermostat, an additional wire is usually required to power and maintain operation of the digital thermostat. When replacing a first digital thermostat with another digital thermostat, the additional power connection wire is normally present.

When installing a digital thermostat for a new application, such as when building a new house, providing continuous power for the digital thermostat by adding the necessary extra power wire is relatively easy. However, in retrofit applications, and specifically, when replacing a mechanical thermostat with a digital thermostat, providing an additional wire for electrical power can be difficult, time consuming and costly.

Therefore, what is needed is a digital thermostat having multiple power capabilities that is adapted for both new installations and for retrofit installations (when an external power supply is not available, because all necessary connections are not present).

Power supplies with switches to supply backup power to digital thermometers exist. In prior-art circuits, the switch always produces a “seam” because of the lack of voltage detecting. This seam can lead to instability or reset of the system.

Prior-art switches are not able to switch to an internal power supply when a drop in an overhigh supply voltage occurs.

Prior-art switches without voltage detection decrease battery performance and lifespan.

Another problem with prior-art thermostats is that programming them can be complicated and time consuming.

### BRIEF SUMMARY OF THE INVENTION

It is accordingly an object of the invention to provide a power supply used in the dual powered thermostat controller that overcomes the above-mentioned disadvantages of the heretofore-know devices and methods of this general type.

With the foregoing and other objects in view there is provided, in accordance with the invention, a switch assembly for switching a digital thermostat from a primary power supply to an auxiliary power supply. The switch assembly includes a switch and voltage detector. The switch connects to a digital thermostat and alternatively to a primary power supply having a voltage and an auxiliary power supply. The auxiliary power supply can be a battery, generator, solar panel, separate electrical line, or other backup power source.

The voltage detector signals the switch to connect the digital thermostat to the auxiliary power supply when a change in the voltage of the primary power supply is detected. By detecting a change in voltage, the voltage detector can make the switch before the power is actually interrupted. Likewise, changes in voltage will cause a switch to occur to protect the system even when the primary power source has an overhigh supply voltage.

In accordance with a further object of the invention, a power supply for preventing a power interruption in a primary power supply from affecting a digital thermostat is encompassed by the invention. The power supply includes the switch assembly discussed previously as well as the auxiliary power supply.

In accordance with a further object of the invention, a digital thermostat assembly with backup power supply is taught. The digital thermostat is similar to the power supply and switch assembly discussed previous but also includes a digital thermostat.

The invention further encompasses a programmable thermostat with a touch screen interface. The programmable thermostat is designed to control building air conditioning, heating, or ventilation equipment for home or building. The touch screen interface displays equipment sunning status and allows users to review the setting, monitor the system running status, and program the thermostat.

To ease programming, the invention includes a user-friendly designed touch-screen thermostat. The touch-screen thermostat comes with a menu-driven interface that allows the user or the installer to easily configure the system and program the running sequence for air-conditioning, heating, and ventilation equipment for home or commercial building. The thermostat displays previous settings and running status of all the connecting equipments. The installer or user can easily monitor the system and change system setting through a menu-driven touch screen interface.

Other features which are considered as characteristic for the invention are set forth in the appended claims.

Although the invention is illustrated and described herein as embodied in a power supply switch for dual powered thermostat, a power supply for dual powered thermostat, and a dual powered thermostat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a block diagram of the power supply and switch for a digital thermostat.

FIG. 2 is a circuit diagram of the voltage detector and the switch.

FIG. 3 is a front side view of a digital thermostat according to the invention with the display activated.

FIG. 4 is a front side view of a mounting plate of the digital thermostat.

FIG. 5 is a rear side view of the digital thermostat.

FIG. 6 is a front side view of the digital thermostat with the screen deactivated.

FIG. 7 is a right side view of the second embodiment of the digital thermostat, which is a mirror image of the left side of the thermostat.

FIGS. 8-9 are front side views of a display for a digital thermostat.

### DETAILED DESCRIPTION OF THE INVENTION

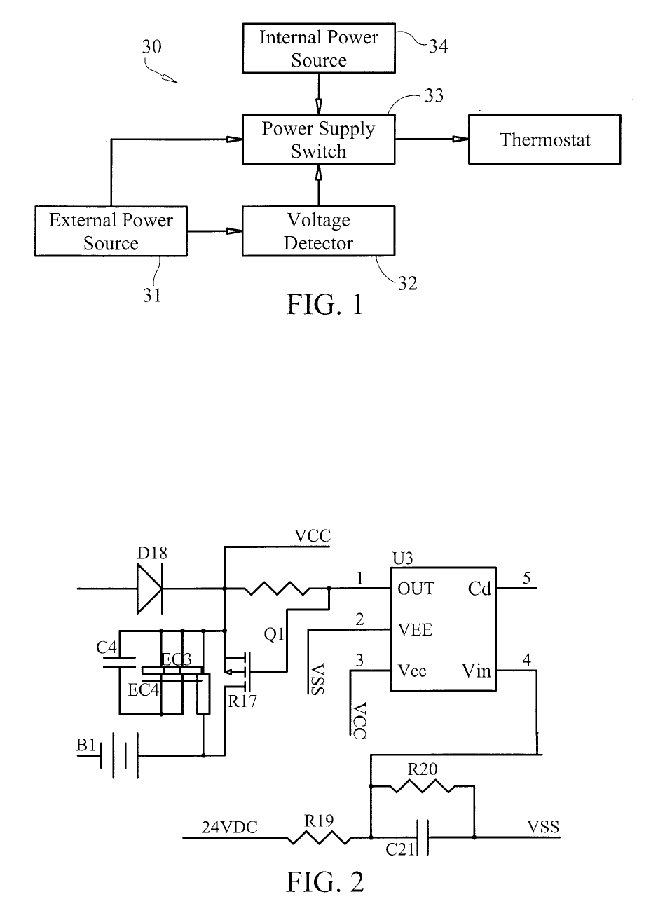

Referring now to the figures of the drawing in detail and first, particularly, to FIG. 1 thereof, a circuit for automatic switching a digital thermostat from external power to internal power is shown. A voltage detecting unit is included in the circuit. The voltage detector is connected to a switch for switching the thermostat to internal power when the external power's voltage begins to drop. In a preferred embodiment, the internal power supply is a battery.

The switch changes to the internal power supply when the switch detects a that the voltage has fallen below a preselected threshold. By checking the decrease, as opposed to the absence of voltage, seams are avoided. Switching voltage sources upon detecting a voltage drop decreases system instability and avoids system resets.

The switch also solves the problem of overhigh voltage drop by including a diode such as a Zener diode.

The switch by avoiding resets and overhigh voltage drops can improve the battery performance and battery life span.

Referring now to the figures of the drawing in detail and first, particularly, to FIG. 1 thereof, a circuit 30 for automatically switching a digital thermostat 35 from an external power source 31 to an internal power source 34 is shown. The external power source is preferably a twenty-four Volt Alternating Current (24Vac) source. The internal power source 34 is preferably two AA batteries connected in series. A voltage detector 32 is disposed between the external power source 31 and the power supply switch 33. The voltage detector 32 is connected to a switch 33 for switching the thermostat 35 to the internal power source 34 when the voltage of the external power supply 31 drops too quickly.

The switch 33 changes to the internal power supply 34 when the voltage detector 32 detects that a voltage of the external power source 31 has fallen below a preselected voltage. By switching when there is still a voltage, albeit a decreased voltage, as opposed to after an absence of voltage, seams are avoided. The system is switched to the internal power source 34 before there is no voltage. Accordingly, system instabilities and resets are avoided.

FIG. 2 shows an electrical circuit diagram of the circuit 30. A diode D18 prevents overhigh voltage.

FIG. 2 shows the circuit operating in a normal state. Incoming AC24 voltage is transformed to three-volt direct-current (3V DC) voltage. The 3V DC voltage is distributed to the system.

When AC24 voltage drops, the fourth foot of U3 chip produces a lower voltage. Thus, the first foot of U3 will produce a voltage to open the CMOS, and the battery can supply power to the whole system accordingly.

When AC24 voltage resumes at a normal value, the forth foot will have a higher voltage. Thus, the first foot will produce a voltage to disconnect the CMOS Q1. The AC24, not the battery, supplies power to the system.

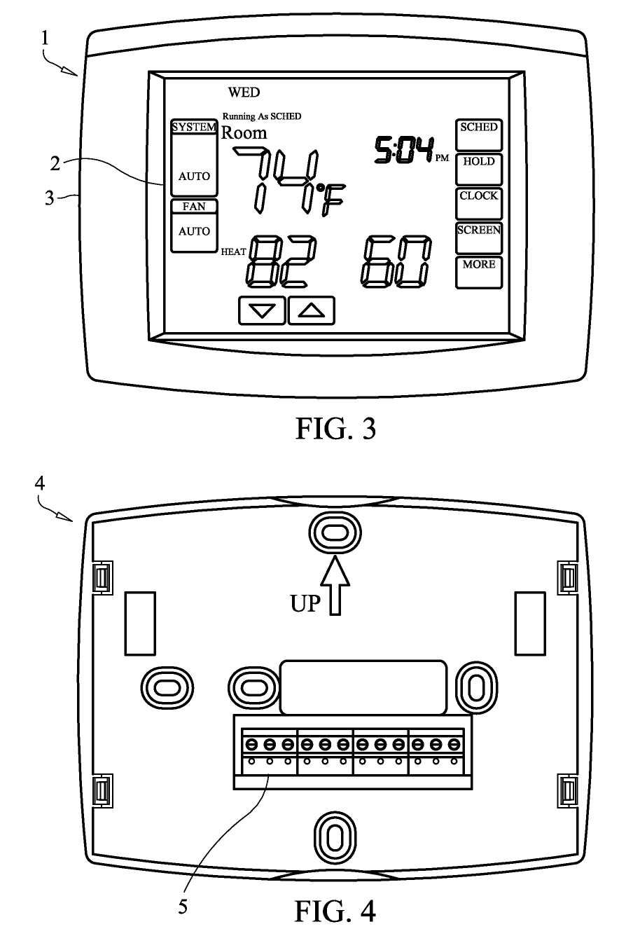

FIG. 3 shows a digital thermostat 1. The thermostat 1 includes a touch screen 2, which is detailed below. A frame 3 surrounds the touch screen 2 and forms the rear thereof.

FIG. 4 shows a mounting plate 4. The mounting pate 4 is affixed on a wall. The mounting plate 4 has a connector 5 for connecting to a HVAC system (not shown).

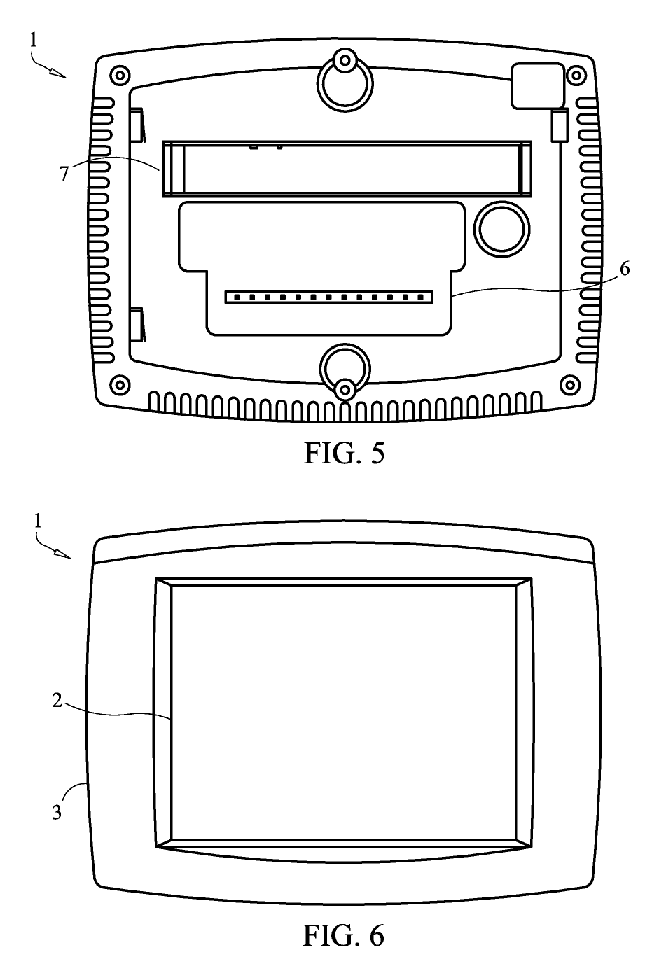

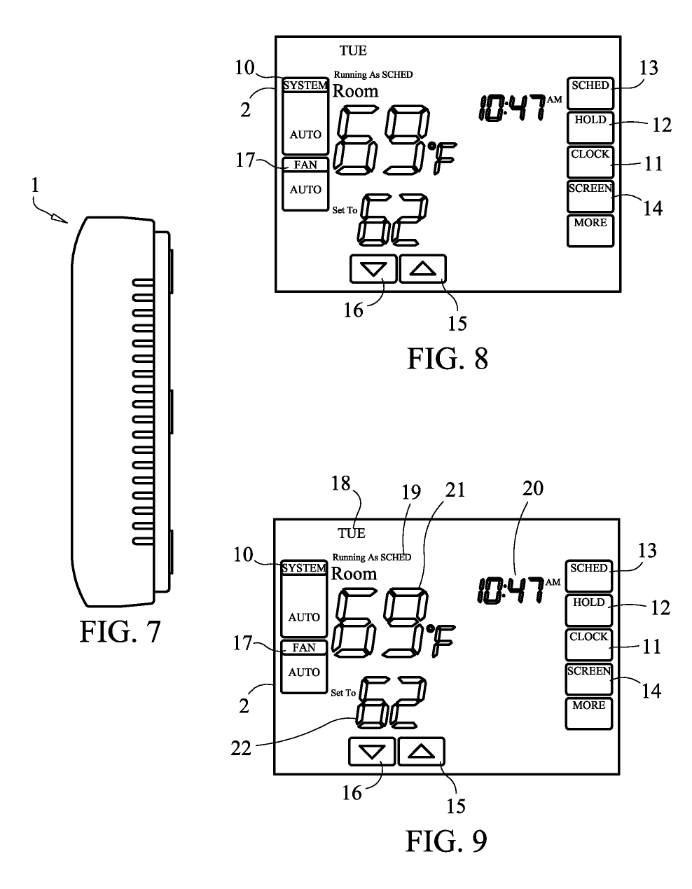

FIG. 5-7 show the digital thermostat 1. FIG. 5 shows the rear of the digital thermostat 1. Disposed on the rear of the digital thermostat 1 is a connector 6. The connector 6 of the digital thermostat 1 couples with the connector 5 of the mounting plate. The digital thermostat 1 can be separated from the mounting plate 4 for easier handling during programming. A battery slot 7 is formed in the rear for holding two AA batteries.

FIGS. 8-9 shows detailed views of the touch screen 2, which is also a display. The touch screen includes a system select 10. By touching the system select 10, a user can select a mode for the thermostat (i.e. heat, off, cool, emergency, or automatic). When not selecting, the system select 10 shows the current mode.

A current time is set by using the clock button 11.

A hold button 12 programs a constant set temperature and bypasses the timer. The hold button 12 is used, for example, to set a temperature when the occupants are on vacation.

A schedule button 13 is used to enter scheduling mode.

A screen button 14 locks the screen for cleaning. When pressed, other regions of the touch screen 2 can be pressed without affecting the controls. The screen button 14 is pressed again to resume normal operation of the screen 2.

An up arrow 15 and down arrow 16 are used to raise and lower, respectively, the temperature setting.

A fan button 17 set the fan mode and switches the fan from on to off to automatic. When not being used to select the fan mode, the fan button 17 displays the selected mode.

A day icon 18 indicates the day of the week. The unit may be programmed for different settings based on the time and day of the week.

A schedule icon 19 indicates that the system is running as scheduled and that the program is not being overridden.

A time icon 20 displays the current time, hold time remaining, or number of vacation days remaining.

A temperature icon 21 displays the inside temperature.

A set temperature icon 22 displays the set temperature.

I claim:

1. A switch assembly for switching a digital thermostat from a primary power supply to an auxiliary power supply, comprising:
a switch having an output to be connected to the digital thermostat and having a first input to be connected to the primary power supply and a second input to be connected to the auxiliary power supply, said switch switching alternatively between said first input and said second input; and
a voltage detector being connected to said switch and being configured to be connected to the primary power supply and signaling said switch to switch to said input to be connected to the auxiliary power supply whenever a voltage of the primary power supply drops below a given voltage.

2. The switch assembly according to claim 1, wherein the auxiliary power supply is a battery.

3. A power supply for preventing a power interruption in a primary power supply from affecting a digital thermostat, comprising:
an auxiliary power supply;
a switch having an output to be connected to the digital thermostat and having a first input to be connected to the primary power supply and a second input connected to said auxiliary power supply, said switch switching alternatively between said first input and said second input; and
a voltage detector being connected to said switch and being configured to be connected to the primary power supply and signaling said switch to switch to said input connected to said auxiliary power supply whenever a voltage of the primary power supply drops below a given voltage.

4. The power supply according to claim 3, wherein said auxiliary power supply is a battery.

5. A digital thermostat assembly with backup power supply, comprising:
a digital thermostat;
an auxiliary power supply;
a switch having an output connected to said digital thermostat and having a first input to be connected to the primary power supply and a second input connected to said auxiliary power supply, said switch switching alternatively between said first input and said second input; and
a voltage detector being connected to said switch and being configured to be connected to the primary power supply and signaling said switch to switch to said input connected to said auxiliary power supply whenever a voltage of the primary power supply drops below a given voltage.

6. The digital thermostat assembly according to claim 5, wherein said auxiliary power supply is a battery.

7. The switch assembly according to claim 1, further comprising a diode for preventing overvoltage connected to said input for the primary power supply.

8. The switch according to claim 1, further comprising:
a processor receiving a given alternating voltage, converting the given alternating voltage to a lower direct voltage, and outputting the lower direct voltage to at least two processor outputs, said processor outputting an ever lower voltage at one of said processor outputs when receiving less than the given alternating voltage;
a CMOS being connected to both of said processor outputs, said CMOS switching to the alternate power supply when one of the processor outputs drops to the even lower voltage.
